(19) United States
(12) Patent Application Publication
(10) Pub. No.: US 2020/0271060 A1
(43) Pub. Date: Aug. 27, 2020

(54) VARIABLE CYCLE FAN FOR MINIMIZING NOISE

(71) Applicants: Rolls-Royce Corporation, Indianapolis, IN (US); Rolls-Royce North American Technologies Inc., Indianapolis, IN (US)

(72) Inventors: Christopher Hall, Indianapolis, IN (US); William Barry Bryan, Indianapolis, IN (US)

(73) Assignees: Rolls-Royce Corporation, Indianapolis, IN (US); Rolls-Royce North American Technologies Inc., Indianapolis, IN (US)

(21) Appl. No.: 16/281,995

(22) Filed: Feb. 21, 2019

(51) Int. Cl. F02C 9/22; F01D 17/14; F02C 3/107

(52) U.S. Cl. CPC F02C 9/22; F01D 17/14; F05D 2260/96; F05D 2220/323; F02C 3/107

(57) ABSTRACT

A system and method for meeting take off noise requirements in a gas turbine engine with a multi-stage fan, comprising an inlet passage, a core passage, a bypass passage and a mid-stage offtake passage; the core passage comprising a core inlet, high pressure compressor, combustor, high pressure turbine, low pressure turbine and a core exhaust; the bypass passage comprising a primary bypass inlet and a primary bypass exit; the mid-stage offtake passage comprising an offtake inlet and offtake exit; a first stage comprising a first rotor, and a second stage comprising a second rotor; and a variable guide vane located axially between the first rotor and the second rotor; an actuator coupled to and selectively varying the variable guide vane between two or more orientations; a variable offtake exit thrust nozzle; and, wherein a gas stream exiting the inlet passage enters one of the core, bypass or mid-stage off take passages as a function of the two or more orientations.

### BACKGROUND

Noise limits, established by Government agencies (FAA, EASA, etc.) regulate the acoustic emissions of aircraft when operating at lower elevations, specifically at takeoff, flyover and approach. Recently changes have been made reducing the noise that may be produced by newly certificated airplanes and harmonizing the noise certification standards for airplanes certificated in the United States with international aviation organizations. Complying with these restrictions during takeoff presents some difficulty, given airports are generally located proximate to population centers and that take-off is a maximum thrust regime. Typically, a trade-off is made to system level requirements for civil engine in order to meet the noise limitations.

For a conventional (non-variable) fan to meet thrust specific fuel consumption (TSFC) and noise requirements (at takeoff) a larger fan is required to lower tip speed and provide the thrust required at a lower fan tip pressure ratio. This results in increased fan weight and a large amount of drag at the aircraft level thereby reducing overall range. The consequence is then to reduce fan size but doing so requires increase fan pressure ratio (PR) to meet thrust which increases take off noise beyond requirements. Pressure ratio is the major contributor to engine noise.

The solution presented herein is the introduction of a fan (and other portions of the engine) with variable features such that the fan can operate in two or more different modes that optimize relevant parameters to respective flight condition,

FIG. 1 represents a two stage fan in a conventional configuration (no variability). This fan has poor noise characteristics for take-off conditions and is heavier compared to its variable cycle alternative (which would include a fan at a smaller size).

### SUMMARY

According to some aspects of the present disclosure, a gas turbine engine may have a multi-stage fan, with an inlet passage, a core passage, a bypass passage and a mid-stage offtake passage. The core passage may include a core inlet, high pressure compressor, combustor, high pressure turbine, a low pressure turbine and a core exhaust. The bypass passage may include a primary bypass inlet and a primary bypass exit. The mid-stage offtake passage may include an offtake inlet and offtake exit. The engine fan may include a first stage rotor, a second stage rotor, and a variable guide vane located axially between the first rotor and the second rotor. An actuator may be coupled to and selectively vary the variable guide vane between two or more orientations, in combination with a variable thrust nozzle at the offtake discharge, which in turn controls whether a gas stream exiting the inlet passage enters one of the core, bypass or mid-stage off take passage.

According to other aspects the first rotor and second rotor may be operably coupled to the same shaft, the shaft may be driven by the turbine. The first and second rotors may be coaxial. The gas turbine may be configured for supersonic or subsonic propulsion. The variable guide vane may be located axially between the offtake inlet and the second rotor. The variable guide vane may be located axially between the first rotor and the offtake inlet. A second variable guide vane position may be axially forward of the first rotor. The actuator for the variable guide vane may be located outboard of the variable guide vane or internal to the hub gas path. The mid-stage offtake passage may be bounded between a radially outer casing and a radially intermediate casing, the bypass passage may be bounded between the intermediate casing and a core casing, and the core passage is bounded between the core casing and an inner casing, wherein the variable guide vane comprises a support strut between the inner casing and the outer casing. The mid-stage offtake passage may be bounded between a radially outer casing and a radially intermediate casing, the bypass passage is bounded between the intermediate casing and a core casing, and the core passage is bounded between the core casing and an inner casing, wherein the variable guide vane comprises a support strut between the inner casing and the intermediate casing. The first and second rotors may be fixed pitch rotors.

Other embodiments may include a method of meeting take-off noise requirement in a gas turbine. The method may involve operating a gas turbine with a multi-stage fan, the multi-stage fan may have a first rotor and a second rotor, creating a pressure increase across each of the first and second rotors by rotating the shaft, setting an offtake flow to a maximum value, setting an overall bypass pressure ratio to at least a minimum value, the maximum and minimum values may be a function of a noise limit at take-off and take-off thrust, the step of setting the overall bypass pressure ratio may include adjusting a variable guide vane positioned axially between the first rotor and the second rotor, along with the offtake variable exit nozzle. The overall bypass pressure ratio may be defined between an inlet of the gas turbine and the bypass stream exit and the offtake flow may be defined between the inlet of the gas turbine and an offset stream exit.

The method of noise control may further include increasing altitude of the gas turbine beyond a predetermined value, decreasing the offtake flow to an offtake minimum value and, increasing the overall bypass pressure ratio from the minimum value until the gas turbine exceeds the noise limit. The offtake flow minimum value may be a function of thrust and SFC. The step of increasing the overall bypass pressure ratio may further include adjusting the variable guide vane and offtake variable thrust nozzle. The noise control method may also include increasing velocity of the gas turbine beyond a predetermined value, decreasing the offtake flow to an offtake minimum value, and increasing the overall bypass pressure ratio from the minimum value until the gas turbine exceeds the noise limit. The offtake minimum value may be a function of thrust and SFC. The step of increasing the overall bypass pressure ratio may include adjusting the variable guide vane and offtake variable thrust nozzle. The noise control method may be aided by an actuator coupled to and selectively adjusting the variable guide vane between two or more orientations of the variable guide vane and a turbine core, the turbine core may drive the first and second rotors. The step of setting an offtake flow to a maximum value may entail increasing the corrected speed of the first rotor.

### BRIEF DESCRIPTION OF THE DRAWINGS

The following will be apparent from elements of the figures, which are provided for illustrative purposes.

FIG. 1 is a conventional two stage fan configuration.

FIG. 2 is a gas turbine with a two stage fan configuration according to an embodiment of the disclosed subject matter.

FIG. 3 is a gas turbine with a two stage fan configurations including a variable inlet guide vane according to embodiments of the disclosed subject matter.

FIG. 4 is a gas turbine with a two stage fan configurations with the offtake inlet located between the variable guide vane and the second rotor according to embodiments of the disclosed subject matter.

FIG. 5 is a flow diagram of a method of operating the variable fan cycle between two flight modes according to embodiments of the disclosed subject matter.

The present application discloses illustrative (i.e., example) embodiments. The claimed inventions are not limited to the illustrative embodiments. Therefore, many implementations of the claims will be different than the illustrative embodiments. Various modifications can be made to the claimed inventions without departing from the spirit and scope of the disclosure. The claims are intended to cover implementations with such modifications.

### DETAILED DESCRIPTION

For the purposes of promoting an understanding of the principles of the disclosure, reference will now be made to a number of illustrative embodiments in the drawings and specific language will be used to describe the same.

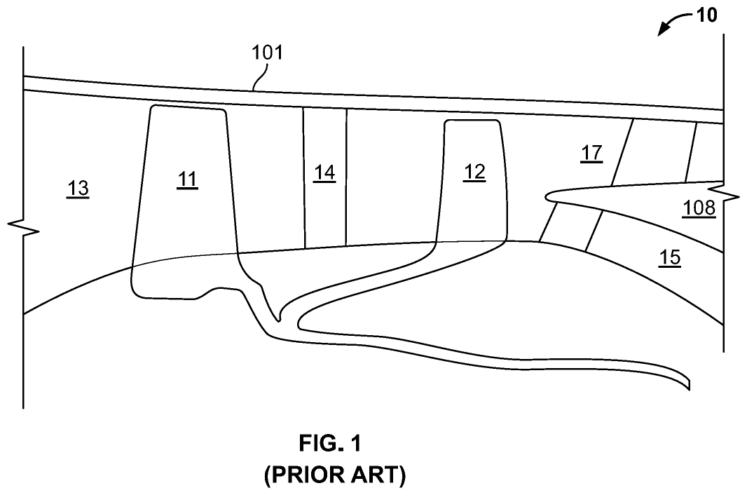

FIG. 1 represents a two stage fan in a conventional configuration (no variability). The two stage fan 10 includes a first rotor 11 and a second rotor 12, between the rotors is a fixed guide vane (stator) 14. Air entering the inlet 13 is operated on by the rotors 11, 12 and continues either through the core 15 or the bypass 17. The outer casing 101 and splitter 103 define portions of the boundary of the inlet 13, bypass 17 and core 15. The thrust generated by the two stage fan 10 is primarily a result of the pressure ratio between the inlet 13 and exit nozzle (not shown) from bypass 17. At takeoff the thrust and thus the pressure ratio would be near their maximums and thus this fan would have poor noise characteristics and be heavier compared to its variable cycle alternative presented herein.

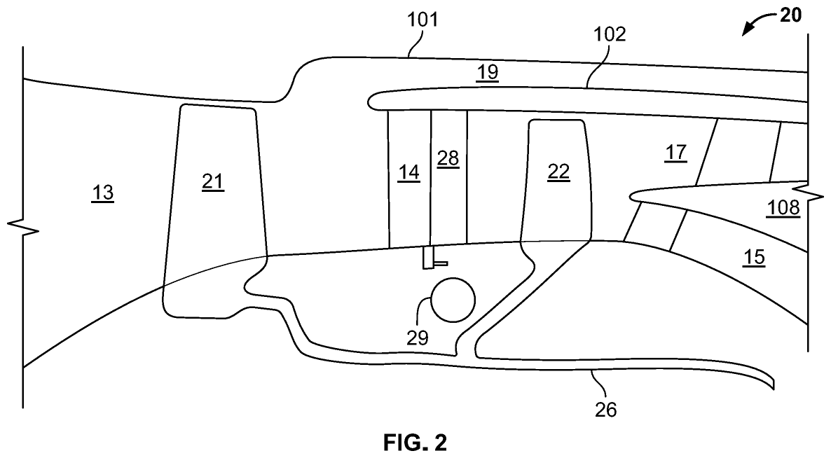

FIG. 2 illustrates an embodiment of a variable cycle fan 20 in which the overall pressure ratio may be reduced without a commensurate reduction of thrust during takeoff or increased pressure ration for TSFC in non-takeoff regimes such as cruise. As shown in FIG. 2, the two stage fan 20 includes a first rotor 21 and a second rotor 22, each rotor driven by shaft 26. In addition to core 15 and bypass 17 passages, an inlet of an offtake passage 19 is located between the first and second rotors. An intermediate structure 102 defines the boundary between the offtake stream 19 and bypass stream 17. A stator 14 and variable guide vane 28 is also positioned between the first and second rotors, the variable guide vane 28 influences the air that is bypassed through offtake 19. The variable guide vane 28 is driven by an actuator 29, shown in FIG. 2 as being inboard of the vane 28, but given the additional outboard space provided with the use of the offtake passage 19, the actuator may be advantageously located outboard. The rotors 21 and 22 are driven by shaft 26, however, it is also envisioned each of the rotors may be driven by a separate spool, or driven through a geared architecture, such that each rotor would advantageously rotate at different design speeds.

The addition of the offtake passage 19 allows the fan 20 to operate in two or more different modes depending on flight condition. For example, during takeoff (a first flight mode) some of the air passes through the first rotor 21 of the 20 fan but not rotor 22, this air is bypassed thru the offtake passage 19 (passage) between two fan rotors. By bypassing air through the offtake passage 19, the overall pressure ratio of the fan 20 exiting the fan via the bypass passage 17 is reduced and keeps the takeoff noise within the regulatory limits. During takeoff conditions the first stage fan rotor 21 is running at a higher corrected speed compared to what a conventional fan would be to meet takeoff thrust (offtake stream flow), thus the pressure ratio across the first rotor 21 may actually increase.

During cruise conditions (another flight mode) the fan 20 does not bypass any or as much air through the offtake 19 and the overall fan pressure ratio may be much higher, absent the noise restrictions, which allows for the same or additional thrust but with a smaller fan size compared to the conventional two stage fan configuration 10 sized to meet takeoff noise requirements. The overall pressure ratio at cruise for the variable cycle engine would violate noise requirements on the ground but in this flight condition has relaxed noise requirements given the higher altitude. The variable stator 29 may be used to control (split) the flow into the offtake stream 19 and thus consequently the flow through the second stage rotor 22, bypass stream 17 and overall bypass pressure ratio.

The flow split into the offtake passage 19 is a function of the size of the rotor 21 and the overall pressure ratio required to provide the thrust during design flight conditions. Increasing the flow split into the offtake passage 19 generally allows for a smaller rotor 21 fan size and generally decreases the two stage fan weight, and comes with additional benefits in terms of installation packaging and integration at the aircraft level. Generally, issues related to installation and integration are simplified with a reduction in engine size.

The overall fan system maximum envelope also decreases with increased flow through the offtake passage 19 (and subsequent rotor fan size decrease). This result is realized because as the flow distribution through the offtake passage 19 increases, the reduction in rotor 21 size increases the low pressure compressors corrected speed which allows for reduced overall fan system size. This, as previously discussed, is of particular benefit for engine/aircraft integration.

As noted previously, a benefit of this system is that it allows for reduced fan size for a constant noise signature below what would be possible for a conventional fan by varying the overall fan PR in a multi-stage fan using one or more variable guide vanes 28 to control the split of air between the offtake stream 19, the bypass stream 17 and the core 15.

The two stage fan 20 in FIG. 1 shows is a cantilevered configuration with the offtake passage 19 positioned between rotor 22 and stator 14. This offtake position offers an axially shorter design since the offtake is positioned at a rotor/stator gap that is naturally already larger.

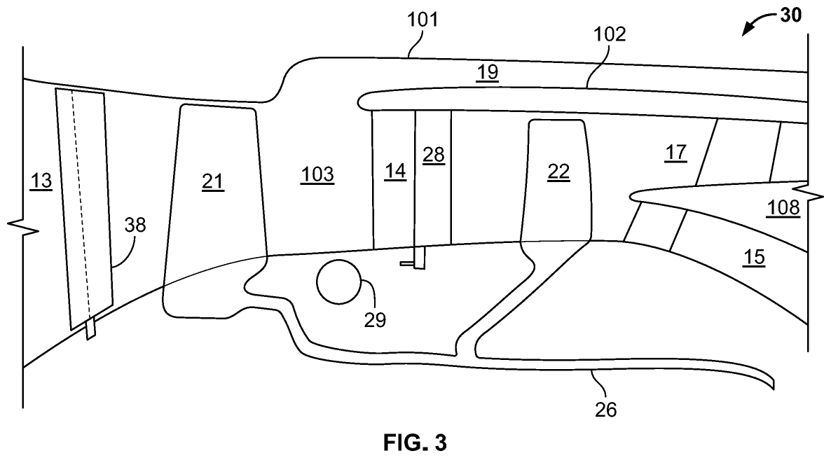

FIG. 3 shows another embodiment of a variable cycle two stage fan 30. In FIG. 3 variable inlet guide vane 38 may also be used in conjunction with the variable guide vane 28 to control the air split into the offtake stream 19. The offtake stream inlet in FIG. 3 is also between the rotor 21 and stator 14.

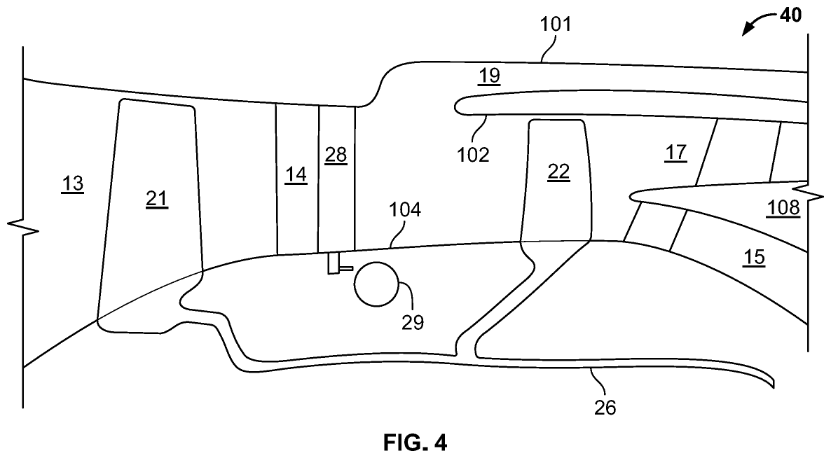

FIG. 4 shows another embodiment of a variable cycle two stage fan 40. In FIG. 4 unlike FIGS. 2 and 3, inlet to the offtake stream 19 is located downstream of the stator 14 and variable guide vane 28 and upstream of the second rotor 22. This configuration increases the length of the fan stage above those in which the offtake inlet is between the rotor 21 and the stator 14 as shown in FIGS. 2 and 3, and includes the addition of a core casing segment 104.

The position the offtake inlet as described above as well as the radial height of the offtake passage 19 may be advantageously varied without departing from the benefits of the variable two stage fan described herein. Additionally, it is envisioned that a multistage fan in which there are more than two fan stages and a corresponding more than one offtake passages may be advantageous to allow a finer granularity to the flight modes while abating acoustic emissions. Additionally, the variable guide vane 28 may be scheduled to split the flow to achieve maximum performance for each flight regime. For example, the operation of the engine during different regimes, such as cruise, loiter, approach, supersonic, high altitude as well as takeoff may be further optimized by scheduling the position of the variable guide vane for each mode.

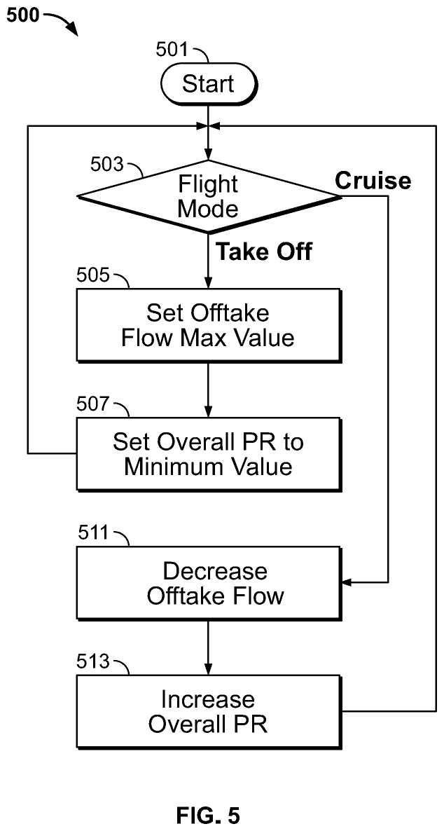

FIG. 5 describes a method 500 for meeting the noise requirements in the flight regimes of takeoff and cruise. The method 500 is describe with respect to an operating gas turbine having a two stage fan, i.e. having a first rotor and a second rotor as shown in Block 501. The flight mode of the aircraft is determined as shown Block 503, as shown in FIG. 5, the two modes are takeoff and cruise, however as previously discussed the method may equally apply to different modes considering the noise limitations of each mode. In the takeoff mode, where it is important to have sufficient thrust but minimize noise emission, the offtake flow is set to a maximum as shown in Block 505. The maximum value is a function of noise limit and the thrust required, particularly it is the pressure ratio where the noise emissions are within the limit and the thrust is sufficient for takeoff, the use of maximum is more of guidance, i.e. , try to stay close to value. In Block 507 the overall bypass pressure ratio is set to at least a minimum value, here the minimum value represents the highest pressure ratio that still meets the noise requirement. These conditions will persist until the flight mode changes, the flight modes may be dictated by altitude and speed ranges as well, for example under 5000 feet. For example, in transitioning from takeoff to cruise, the offtake flow is decreased, the offtake flow being minimized as a function of thrust and TSFC; as shown in Block 511 and the overall bypass pressure ratio is increased past the point to where the gas turbine exceeds the noise limit to reach a value based upon thrust and TSFC as shown in Block 513.

The actions of Blocks 505, 507, 511 and 513 are in part accomplished by adjusting the variable guide vane 28 positioned axially between the first rotor 21 and the second rotor 22, as well as the offtake variable thrust nozzle. The variable guide vane 28 induces or changes the swirl of the stream which varies the split between the offtake stream 19 and the bypass stream 17 and consequentially varies the respective pressure ratios of each stream. Other methods for varying the pressure ratios are also envisioned but may be less desirable such as varying the offtake inlet area or opening and closing doors in offtake stream.

As described above and additionally, there are several disparate benefits that accompany the use of embodiments of the variable fan cycles, among them are: smaller fan sizes without reducing thrust or increasing noise; smaller maximum fan diameter envelope; simpler aircraft integration; improved fan efficiency; improved propulsive efficiency by increasing the effective bypass ratio at lower aircraft speeds, reduced bird size testing for certification (i.e. the number and size of birds the engine is required to handle is reduced); blisk weight reduction; improved crosswind operability; surge margin; ease of manufacturing; reduced need to correct inlet air distortions; better stage matching for each flight condition; additional mount options/load paths given the added structure required by the offtake stream, as well as the presence of the stator; additional benefits for fan containment given the additional barrier of the offtake passage; avoidance of TO flutter bite; fan operating range reduction and thus the fan may be optimized more to corrected speed; added flexibility to move bearing locations; better vane ice mitigation; and higher low pressure spool speed/more efficient Low pressure turbine/lower turbine stage count.

An aspect of the disclosed subject matter is that the effective bypass ratio (the combined flow through the offtake passage 19 and the bypass passage 17 divided by the flow through the core 15) is increased in noise limited environments (e.g. takeoff, approach, fly over, etc.) and decreased in environments where noise is not an issue (e.g., cruise).

Although examples are illustrated and described herein, embodiments are nevertheless not limited to the details shown, since various modifications and structural changes may be made therein by those of ordinary skill within the scope and range of equivalents of the claims.

What is claimed is:

1. A gas turbine engine with a multi-stage fan, comprising
an inlet passage, a core passage, a bypass passage and a mid-stage offtake passage; the core passage comprising a core inlet, a turbine and a core exhaust;
the bypass passage comprising a primary bypass inlet and a primary bypass exit;
the mid-stage offtake passage comprising an offtake inlet and a variable thrust offtake exit nozzle;
a first stage comprising a first rotor, and a second stage comprising a second rotor; and
a variable guide vane located axially between the first rotor and the second rotor;
an actuator coupled to and selectively varying the variable guide vane between two or more orientations; and,
wherein a gas stream exiting the inlet passage enters one of the core, bypass or mid-stage off take passages as a function of the two or more orientations.

2. The gas turbine of claim 1, wherein the first rotor and second rotor are operably coupled to the same shaft, the shaft being driven by the turbine.

3. The gas turbine of claim 1, wherein the first and second rotors are coaxial.

4. The gas turbine of claim 1, wherein the gas turbine is configured for supersonic propulsion.

5. The gas turbine of claim 1, wherein the variable guide is located axially between the offtake inlet and the second rotor.

6. The gas turbine of claim 1 wherein the variable guide vane is located axially between the first rotor and the offtake inlet.

7. The gas turbine of claim 5, further comprising a second variable guide vane position axially forward of the first rotor.

8. The gas turbine of claim 5, further comprising the actuator for the variable guide vane located outboard of the variable guide vane.

9. The gas turbine of claim 1, wherein the mid-stage offtake passage is bounded between a radially outer casing and a radially intermediate casing, the bypass passage is bounded between the intermediate casing and a core casing, and the core passage is bounded between the core casing and an inner casing, wherein the variable guide vane comprises a support strut between the inner casing and the outer casing.

10. The gas turbine of claim 1, wherein the mid-stage offtake passage is bounded between a radially outer casing and a radially intermediate casing, the bypass passage is bounded between the intermediate casing and a core casing, and the core passage is bounded between the core casing and an inner casing, wherein the variable guide vane comprises a support strut between the inner casing and the intermediate casing.

11. The gas turbine of claim 1, wherein the first and second rotors are fixed pitch rotors.

12. A method of meeting take-off noise requirement in a gas turbine, comprising;
operating a gas turbine with a multi-stage fan, the multi-stage fan having a first rotor and a second rotor,
creating a pressure increase across each of the first and second rotors by rotating the shaft;
setting an offtake flow to a maximum value;
setting an overall bypass pressure ratio to at least a minimum value, the maximum and minimum values being a function of a noise limit at take-off and take-off thrust;
wherein the step of setting the overall bypass pressure ratio comprises adjusting a variable guide vane positioned axially between the first rotor and the second rotor and adjusting an offtake discharge variable thrust nozzle;
wherein the overall bypass pressure ratio is defined between an inlet of the gas turbine and the bypass stream exit.

13. The method of claim 12, further comprising:
increasing altitude of the gas turbine beyond a predetermined value;
decreasing the offtake flow to an offtake minimum value; and,
increasing the overall bypass pressure ratio from the minimum value until the gas turbine exceeds the noise limit; wherein the offtake minimum value is a function of thrust and SFC;
wherein the step of increasing the overall bypass pressure ratio comprises adjusting the variable guide vane and adjusting the offtake discharge variable thrust nozzle.

14. The method of claim 12, further comprising:
increasing velocity of the gas turbine beyond a predetermined value;
decreasing the offtake flow to an offtake minimum value; and,
increasing the overall bypass pressure ratio from the minimum value until the gas turbine exceeds the noise limit; wherein the offtake minimum value is a function of thrust and SFC;
wherein the step of increasing the overall bypass pressure ratio comprises adjusting the variable guide vane and adjusting the offtake discharge variable thrust nozzle.

15. The method of claim 14, wherein the predetermined value is supersonic.

16. The method of claim 14, wherein the predetermined value is cruise speed.

17. The method of claim 13, wherein the predetermined value is cruise altitude.

18. The method of claim 13, wherein the predetermined value is a noise abatement ceiling.

19. The method of claim 12, wherein the gas turbine comprises:
an actuator coupled to and selectively adjusting the variable guide vane between two or more orientations of the variable guide vane and a turbine core, the turbine core driving the first and second rotors.

20. The method of claim 12, wherein the step of setting an offtake flow to a maximum value comprises increasing the corrected speed of the first rotor.
